(19) United States
(12) Patent Application Publication
(10) Pub. No.: US 2003/0201889 A1
(43) Pub. Date: Oct. 30, 2003

(54) Remote security condition detection and notifcation system

(76) Inventor: Terry Zulkowski, Needville, TX (US)

Correspondence Address: Raymond R. Ferrera, Esq., Intellectual Property Services, 2502 Lively Lane, Sugar Land, TX, 77479, US

(21) Appl. No.: 10/107,838

(22) Filed: Mar. 27, 2002

(51) Int. Cl. G08B 1/08

(52) U.S. Cl. 340/539.1; 340/506

(57) ABSTRACT

A remote security condition detection and notification system is provided comprising a security condition detection and notification apparatus capable of uplinking a digital radio signal to a widespread digital two-way radio communication network, and a programmable wireless digital telephone capable of downlinking a digital radio signal from said widespread digital two-way radio communication network, wherein data regarding the detection of one or more of a plurality of predetermined security conditions can be uplinked to the digital two-way radio network via a transmitter in the detection and notification apparatus, and then quickly downlinked from the digital two-way radio network to a receiver disposed in the remote programmable wireless digital telephone in such a manner that an operator of said remote programmable wireless digital telephone can obtain information regarding the precise nature of the detected security condition.

### CROSS-REFERENCE TO RELATED APPLICATIONS

Not Applicable

### STATEMENT REGARDING FEDERALLY SPONSORED DEVELOPMENT

Not Applicable

### BACKGROUND OF THE INVENTION

1. Field of the Invention

The present invention relates generally to the field of remote security condition detection and notification systems, and more particularly to a system wherein a remote operator of a programmable wireless digital telephone can combine existing digital two-way radio technology with a security condition detection and notification apparatus so as to permit the operator to be quickly notified of the detection of one or more of a plurality of predetermined security conditions, regardless of the distance between the operator and the security condition detection and notification apparatus.

2. Background of the Invention

The instant invention is achieved by adapting several previously existing technologies into a new and useful combination security system. Those of ordinary skill in the appropriate arts will recognize that while each of the system components described below are known to learned practitioners in their respective fields, never before has such a combination of these devices been taught or suggested as described herein.

In particular, the instant invention requires that a programmable wireless digital telephone have downlink access from a widespread digital two-way radio network having sufficient operational range as to allow an operator to receive a digital radio signal communication initiated by a transmitter disposed in a security condition detection and notification apparatus whenever a sensing detector within the detection and notification apparatus detects the presence of one or more of a plurality of predetermined security conditions and communicates a signal indicative of the nature of said security conditions to said signal transmitter.

When said one or more of a plurality of predetermined security conditions has been detected by said sensing detector, and then a signal indicative of the nature of said security conditions has been transmitted by said transmitter to a remote operator via an uplink to said widespread digital two-way radio network, the programmable wireless digital telephone must be capable of communicating various detection and transmission notification data to said operator, for example, by means of a series of predetermined tones, pulses or rings or the like, or instead by means of a alphanumerical text message displayed by said programmable wireless digital telephone in a text box.

Such widespread digital two-way radio network services may presently be acquired by an operator through, for example, Nextel Communications, Inc., currently headquartered in Reston, Va., though those of ordinary skill in the art will appreciate that any similarly equipped widespread digital two-way radio communication network would be equally effective in satisfying the spirit and scope of the instant invention, provided that both the operator's programmable wireless digital telephone and the security detection and notification apparatus are equipped so as to permit mutual communication by way of said widespread digital two-way radio network, and provided the effective operating range of said widespread digital two-way radio network is sufficiently expansive as to permit the operator's receipt of transmitted security notification data regarding the detection of one or more predetermined security conditions over very large distances, for example, ranging from a minimum distance occurring within the effective detection range of said sensing detector in said security condition detection and notification apparatus, to a maximum occurring as far as the span of an entire state, or the entirety of the United States, or even worldwide, depending on the effective operational range of the network.

In a presently available representative embodiment of such technology, Nextel Communications, Inc.'s “Direct Connect” network allows two or more operators of programmable wireless digital telephones to communicate with one another by way of a digital two-way radio network over great distances (at present, approximately 2,000 miles) over a fast, reliable, private digital radio frequency, and to allow each of the operators to digitally program their respective wireless digital telephones so as to permit operators to ascertain the identity of any other operator attempting to initiate communications over the digital two-way radio network.

For example, if a first system operator is attempting to communicate with a second system operator over a remote distance of many miles (for example, across two or more states that lie within the effective operating range of Nextel's digital two-way radio network), the first operator can simply uplink a signal transmission by means of a transmitter disposed within their programmable wireless digital telephone directly to the Nextel digital two-way radio network (whether by means of a series of land transmitters, or by one or more satellites, or by any other suitable medium), which in turn downlinks a fast and reliable private digital radio communication signal to the second operator in said remote location by means of a digital radio signal receiver disposed in their similarly equipped programmable wireless digital telephone. Depending upon the manner in which the second operator has programmed their programmable wireless digital telephone, the incoming, downlinked transmission signal can effectively communicate the identity of the signal's initial sender through a distinct, predetermined series of electronic pulses, tones or rings or the like. If the second operator has programmed their wireless digital telephone to define the identity of the sender of an incoming communication by means of a text box or the like disposed within the telephone, the text box can simply display the name of the signal's initial sender, or any other predetermined message that will facilitate identification of the sender.

Despite the many convenient advantages of such a widespread digital two-way radio network, nowhere to date has a system been realized wherein the afore-described technology has been combined with one or more security detection and notification apparatus so as to permit a remote operator to also be quickly transmitted a notification signal regarding the detection of one or more of a plurality of predetermined security conditions so that the operator can quickly initiate a counter-response to the detection of said security condition.

Likewise, there is also well known a number of security detection devices and systems capable of notifying a nearby human or electronic controller or the like of the detection of one or more of a plurality of predetermined security events, such as an unauthorized home intrusion or the like. For example, many previously known home security systems contain devices that can detect the existence of motion or entry within a monitored area, as well as a function for notifying a nearby human monitor or electronic controller or the like so that said controller can contact the system's owner or operator by means of a conventional telephone call, for example, or perhaps by means of a two-way radio frequency communication signal, provided that the distance between the system's human monitor or electronic controller and the owner of the monitored property is not too great (perhaps a few hundred feet at most). However, these systems are invariably dependent upon human intervention or communications between the security system and an external electronic controller of some type, and are thus inherently less reliable than a system wherein the security condition detection apparatus and the owner of the property communicate directly by means of a widespread digital two-way radio communication network.

In view of the combined shortcomings of the widespread programmable wireless telephone network and the home security detection systems described above, the instant invention proposes to combine the advantages of both so as to permit an extremely remote operator to quickly learn of the detection of one or more of a plurality of predetermined security conditions regardless of the distance between the operator and the security condition detection and notification apparatus.

3. Object of the Invention

The primary object of the instant invention is to allow a remote operator of a programmable wireless digital telephone having downlink access from a widespread digital two-way radio network to be transmitted a direct, fast and private notification signal regarding the detection of one or more of a plurality of predetermined security conditions via a security condition detection and notification apparatus regardless of the distance between the operator and the security condition detection and notification apparatus, provided the operator is within the effective operational range of a digital two-way radio communication network, and provided said programmable wireless digital telephone and said security condition detection and notification apparatus are both equipped so as to permit an operable digital two-way radio communication state between the respective devices over large distances.

### BRIEF SUMMARY OF THE INVENTION

A remote security condition detection and notification system is provided comprising a security condition detection and notification apparatus capable of up linking a digital radio signal to a widespread digital two-way radio communication network, and a programmable wireless digital telephone capable of downlinking a digital radio signal from said widespread digital two-way radio communication network, wherein data regarding the detection of one or more of a plurality of predetermined security conditions can be uplinked via a transmitter in the detection and notification apparatus to the digital two-way radio network, and then quickly downlinked from the digital two-way radio network to a receiver disposed in the remote programmable wireless digital telephone in such a manner that an operator of said remote programmable wireless digital telephone can obtain information regarding the precise nature of the detected security condition(s).

### BRIEF DESCRIPTION OF THE DRAWINGS

FIG. 1 is a block diagram depicting a systemic representation of the present invention wherein a digital radio communication transmission is uplinked from a security condition detection and notification apparatus to a widespread digital two-way radio communication network, and then downlinked to a remote programmable wireless digital telephone; and

FIG. 2 depicts a security condition detection and notification apparatus having a sensory detector for detecting one or more of a plurality of predetermined security conditions, and a transmitter for transmitting a security condition notification signal to a remote operator according to a further aspect of the instant invention.

### DETAILED DESCRIPTION OF THE INVENTION

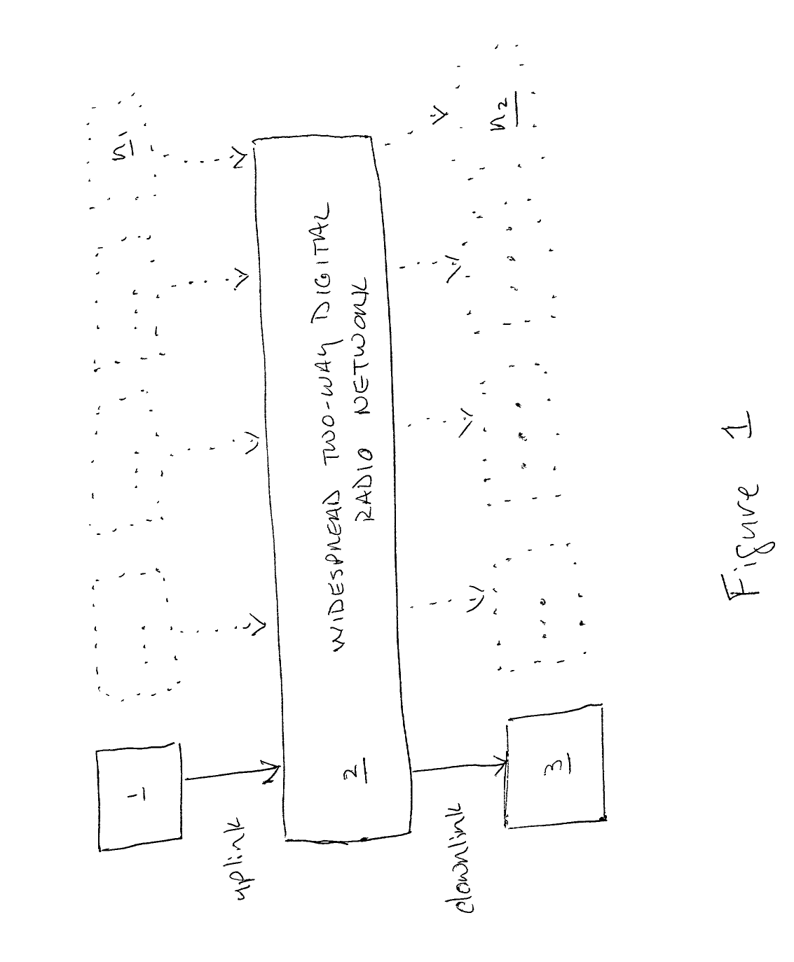

Referring now to FIG. 1, a remote security condition detection and notification system is depicted comprising a security condition detection and notification apparatus 1, a widespread digital two-way radio network 2, and a remote programmable wireless digital telephone 3. As seen, the digital two-way radio network may simultaneously be in use to couple communications between a host of other users and devices, n1-n2. However, in order to fully realize the defining advantages of the instant invention, the digital two-way radio network 2 must at all times be capable of receiving a digital radio signal uplinked from the security condition and notification apparatus 1 and then quickly downlinking a corresponding digital radio signal to the remote programmable wireless digital telephone 3.

The widespread digital two-way radio network 2 and remote programmable wireless digital telephone 3 may be of virtually any known compatible type, provided they are equipped such that widespread digital two-way radio network 2 remains available to receive uplinked digital radio signals transmitted from security condition detection and notification apparatus 1 at all times, and also available to downlink a corresponding digital radio signal to remote programmable wireless digital telephone 3 as long as remote programmable wireless digital telephone 3 remains within the effective operational range of widespread digital two-way radio network 2.

In the event an operator of remote programmable wireless digital telephone 3 should inadvertently turn off the device or venture beyond the effective operational range of widespread digital two-way radio network 2 during a period in which security condition detection and notification apparatus 1 transmits a security condition notification signal via a transmitter disposed within said detection and notification apparatus 1 to the network, widespread digital two-way radio network 2 should store the uplinked transmission in a readily retrievable manner until such time as the operator of remote programmable wireless digital telephone 3 returns the device to an “on” setting or again returns to a location disposed within the effective operating range of widespread digital two-way radio network 2, so that the network can then immediately downlink the data signal transmitted from security condition detection and notification apparatus 1 to remote programmable wireless digital telephone 3 as soon as widespread digital two-way radio network 2 can electronically confirm that remote programmable wireless digital telephone 3 is again on-line within the network.

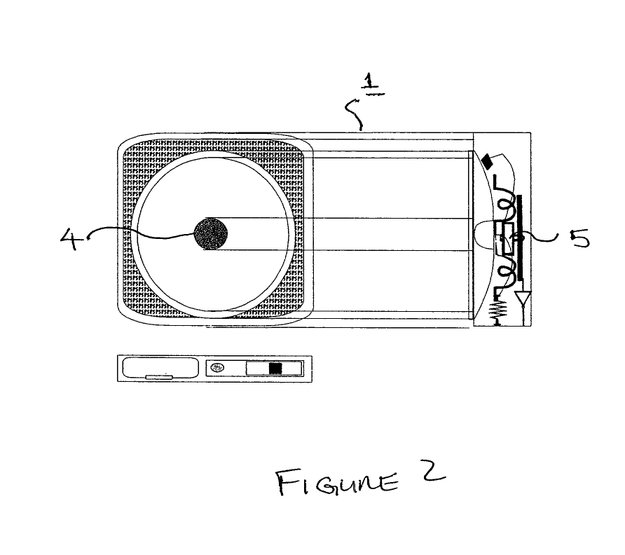

Referring now to FIG. 2, security condition detection and notification apparatus 1 can also be of a previously known type, provided detection and notification apparatus 1 further comprises a sensing detector 4 for detecting one or more of a plurality of predetermined security conditions, and a transmitter 5 for uplinking a transmitted notification signal indicating the detection of said one or more plurality of predetermined security conditions detected by sensing detector 4 to widespread digital two-way radio network 2 for downlink relay to remote programmable wireless digital telephone 3.

Many such predetermined security conditions may be monitored simultaneously be a plurality of sensing devices 4, if desired. For example, sensing detector 4 may comprise one or more of a motion sensor for sensing motion dependent security conditions or unauthorized entry or the like within a monitored area; an audio-sensitive device for detecting noise dependent security conditions; a listening device or the like, for example, a microphone, to permit a remote operator to listen to conditions within the monitored area; weather-sensitive instruments for determining a variety of data regarding the temperature, humidity or precipitation in a monitored area; a pressure sensor or the like for detecting the presence of one or more of a plurality of dangerous inhalants or contaminants, for example, smoke, carbon dioxide, hydrogen sulfide or natural gas; or even a clock for alerting a remote operator that an anticipated security event has not occurred within a predetermined time period.

In each instance, detection of a predetermined security condition can subsequently be indicated to the remote operator by means of a discrete, corresponding signal, such as a series of rings, tones or pulses or the like, created by remote programmable wireless digital telephone 3, so as to notify the operator of the precise nature of the particular predetermined security condition detected by sensing detector 4. In a particularly preferred embodiment of the invention, a text field (for example, an LED display) disposed on or within the body of remote telephone 3 can display an alphanumeric message so that the remote operator can simply read a brief description of the related security event, such as “Motion through patio doorway detected” or “Temperature in excess of 80 degrees detected” or the like so that the operator can quickly initiate a counter-measure related to the security condition. In the examples provided immediately above, an appropriate countermeasure to “Motion through patio door detected” might be to telephone an appropriate police agency to request an investigation of the source of the motion if no such activity is expected; likewise, an appropriate counter-measure to “Temperature in excess of 80 degrees detected” might be to telephone a neighbor and ask that an air conditioning unit be turned on for the health and safety of pets, etc.

The only practical limitations of the remote security condition detection and notification system taught herein are the limits of the effective operational range of the widespread digital two-radio network being used, and the type and nature of security conditions that a remote operator may wish to have monitored. Provided a given security condition can be monitored within the scope of the examples provided above or logical equivalents thereof, and provided a brief message can ultimately be output by a programmable wireless digital telephone so that a remote operator can discern the nature of a detected security condition, virtually any type of instant notification service can be obtained so long as the operator maintains his remote wireless telephone within the effective operating range of the associated widespread digital two-way radio network.

The foregoing specification is provided for illustrative purposes only, and is not intended to describe all possible aspects of the present invention. Moreover, while the invention has been shown and described in detail with respect to several exemplary embodiments, those of ordinary skill in the pertinent arts will appreciate that minor changes to the description, and various other modifications, omissions and additions may also be made without departing from either the spirit or scope thereof. Having herein described the general nature and characteristics of the invention, what is claimed is:

1. A remote security condition detection and notification system comprising:
a security condition detection and notification apparatus capable of uplinking a digital radio signal to a widespread digital two-way radio communication network; and
a programmable wireless digital telephone capable of downlinking a digital radio signal from said widespread digital two-way radio communication network.

2. The remote security condition detection and notification system of claim 1, wherein said security detection and notification apparatus further comprises a sensing detector for detecting one or more of a plurality of predetermined security conditions.

3. The remote security condition detection and notification system of claim 2, wherein said one or more predetermined security conditions comprises a motion dependent security condition.

4. The remote security condition detection and notification system of claim 2, wherein said one or more predetermined security conditions comprises an audio dependent security condition.

5. The remote security condition detection and notification system of claim 2, wherein said one or more predetermined security conditions comprises a precipitation dependent security condition.

6. The remote security condition detection and notification system of claim 2, wherein said one or more predetermined security conditions comprises a temperature dependent security condition.

7. The remote security condition detection and notification system of claim 2, wherein said one or more predetermined security conditions comprises a humidity dependent security condition.

8. The remote security condition detection and notification system of claim 2, wherein said one or more predetermined security conditions comprises a time dependent security condition.

9. The remote security condition detection and notification system of claim 2, wherein said sensing detector for detecting said one or more of a plurality of predetermined security conditions effectively detects the presence of said one or more of a plurality of predetermined security conditions within a range of less than around two hundred feet.

10. The remote security condition detection and notification system of claim 2, wherein said sensing detector for detecting one or more of a plurality of predetermined security conditions effectively detects the presence of said one or more of a plurality of predetermined security conditions to a range of more than around two hundred feet.

11. The remote security condition detection and notification system of claim 1, wherein said security detection and notification apparatus further comprises:
a sensing detector; and
a transmitter for transmitting a notification signal to a remote operator via a widespread digital two-way radio network when one or more of a plurality of predetermined security conditions has been detected by said sensing detector.

12. The remote security condition detection and notification system of claim 11, wherein said transmitter for transmitting a notification signal further comprises a digital signal transmitter.

13. The remote security condition detection and notification system of claim 11, wherein said transmitter for transmitting a notification signal further comprises an analog radio frequency signal transmitter.

14. The remote security condition detection and notification system of claim 12, wherein said digital signal transmitter is a digital two-way radio signal transmitter.

15. The remote security condition detection and notification system of claim 11, wherein said sensing detector further comprises a listening device such as a microphone.

16. The remote security condition detection and notification system of claim 11, wherein said sensing detector further comprises a pressure sensor.

17. The remote security condition detection and notification system of claim 16, wherein said pressure sensor senses pressure data related to the detection of smoke.

18. The remote security condition detection and notification system of claim 16, wherein said pressure sensor senses pressure data related to the detection of carbon dioxide.

19. The remote security condition detection and notification system of claim 16, wherein said pressure sensor senses pressure data related to the detection of hydrogen sulfide.

20. The remote security condition detection and notification system of claim 16, wherein said pressure sensor senses pressure data related to the detection of natural gas.
